(19) United States
(12) Patent Application Publication
(10) Pub. No.: US 2007/0203985 A1
(43) Pub. Date: Aug. 30, 2007

(54) Response linking in instant messaging

(76) Inventors: Michael N. Abernethy JR., Pflugerville, TX (US); Travis M. Grigsby, Austin, TX (US); Justin K. Hong, Sugar Land, TX (US); Charles V. Rankin, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/354,493

(22) Filed: Feb. 15, 2006

(51) Int. Cl. G06F 15/16

(52) U.S. Cl. 709/206

(57) ABSTRACT

A method, apparatus and computer-usable medium are presented for, in a text messaging (e.g., instant messaging-IM) application, displaying a visual cue on a User Interface (UI) that associates a response text message with one of a plurality of received text messages.

### BACKGROUND OF THE INVENTION

1. Technical Field

The present invention relates in general to the field of computers, and specifically to the field of instant text messaging. More specifically, the present invention relates to linking response text messages to received text messages.

2. Description of the Related Art

E-mail applications allow a first computer user to send a text/graphic message to a second computer user. The e-mail is typically sent from a sending client computer to a receiving client computer via an e-mail server, which stores e-mail for the receiving client computer until such time as a receiving user “opens” the e-mail in an e-mail application on the receiving client computer. A popular variation of traditional e-mail is “text messaging,” also known as “instant messaging” (IM). In a text message (IM) scenario, the sender and receiver virtually share a same instant message window, which displays text in a streaming manner, or more commonly, each time the sender depresses the “Enter” key. That is, each time the sender depresses the “Enter” key, whatever text has been typed by the sender since the last time he depressed the “Enter” key is packeted and sent to the receiver.

An exemplary IM User Interface (UI) 100 is shown in FIG. 1a. A user “Travis” has received two questions (102 and 104) from a remote sender. Intending to respond to question 102, “Travis” has typed “yes” as answer 106. However, it is ambiguous as to which question (102 or 104) the answer “yes” is responding to. That is, it may appear that Travis is stating that he is going to play poker tonight (true), or it may appear that Travis is stating that he is the employee who sent the nasty e-mail to his boss (false). Obviously, such an e-mail may be used to the detriment of Travis and his career status if this IM message is interpreted to mean that he is confessing to sending the nasty e-mail to his boss. To avoid such confusion, Travis may type a detailed and clarifying answer 108, as shown in FIG. 1b. However, this requires additional keystrokes, which is contrary to the customary practice of using abbreviated syntax when using IM.

### SUMMARY OF THE INVENTION

Thus, there is a need for a method to make a clear distinction as to which specific received text message is being responded to by a specific response message. To address this need, a method, system and computer-readable medium are presented for, in a text message (e.g., instant messaging-IM) application, displaying a visual cue on a User Interface (UI) that associates a response text message with one of a plurality of received text messages.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1a illustrates a typical prior art User Interface (UI) for a text messaging application in which the message sender has asked two questions in a same message;

FIG. b depicts a prior art method for answering a specific question shown in FIG. 1a;

FIG. 2a illustrates a UI for a text messaging application that utilizes the a novel linkage to show which question is being answered by a responder through the use of a visual arrow pointer;

FIG. 2b depicts a UI for a text messaging application that utilizes a pop-up window to show which question is being answered by a responder;

FIG. 3 is a flow-chart of exemplary steps taken to associate a response message (e.g., an answer) to a specific one of multiple received messages (e.g., questions) in a text messaging (e.g., IM) environment; and

FIG. 4 depicts an exemplary local receiving computer and network in which the present invention may be implemented.

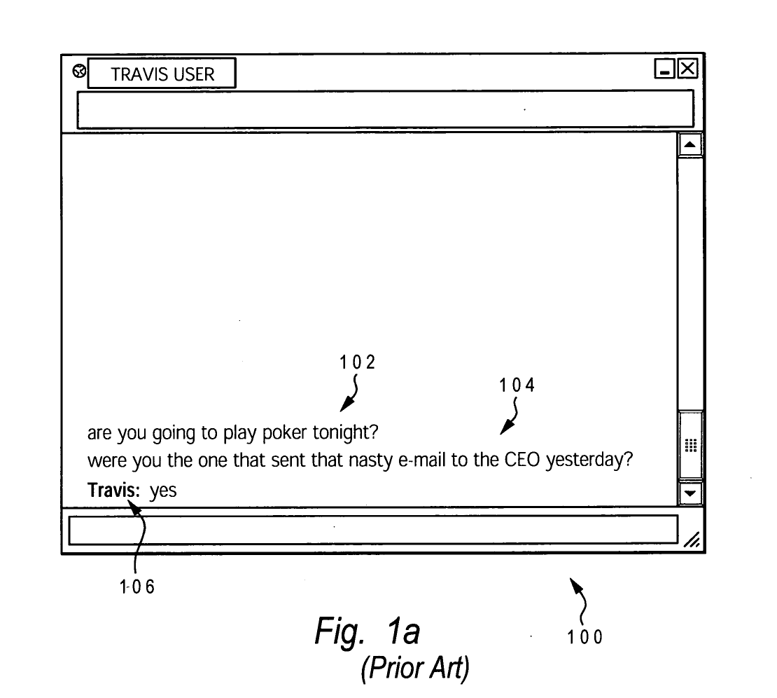

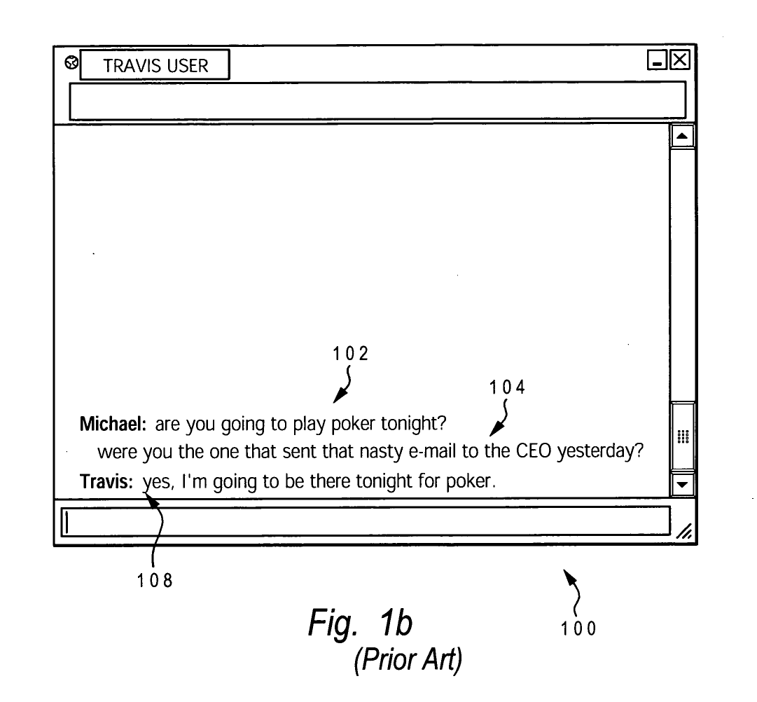

### DETAILED DESCRIPTION OF THE PREFERRED EMBODIMENT

A method, apparatus and computer-usable medium are presented, in an instant text messaging application that displays instant text messages on a User Interface (UI), for displaying, on the UI, a visual cue that associates a response text message with one of a plurality of received text messages. In one embodiment, the visual cue is a line that graphically connects the response text message to one of the plurality of received text messages. In another embodiment, the visual cue is a pop-up window that textually describes an association of the response text message with one of the plurality of received text messages. In one embodiment an association of the response text message defaults to a last received text message. That is, the visual cue automatically can link the response text message with the last received text message (as a default condition). Optionally, the association between the response text message and the received text message can be aurally presented in an aural cue that associates the response text message with the one of the plurality of text messages. In a preferred embodiment, the visual (or aural) cue is transmitted back to the sending unit that sent the plurality of received text messages, which then displays (visually or aurally) the cue that links the response message with the originally sent (received) text message.

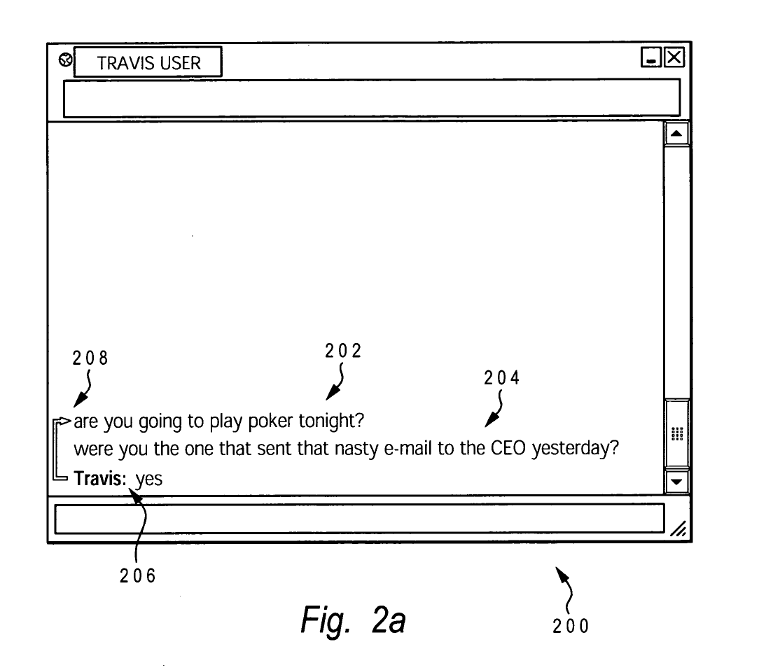

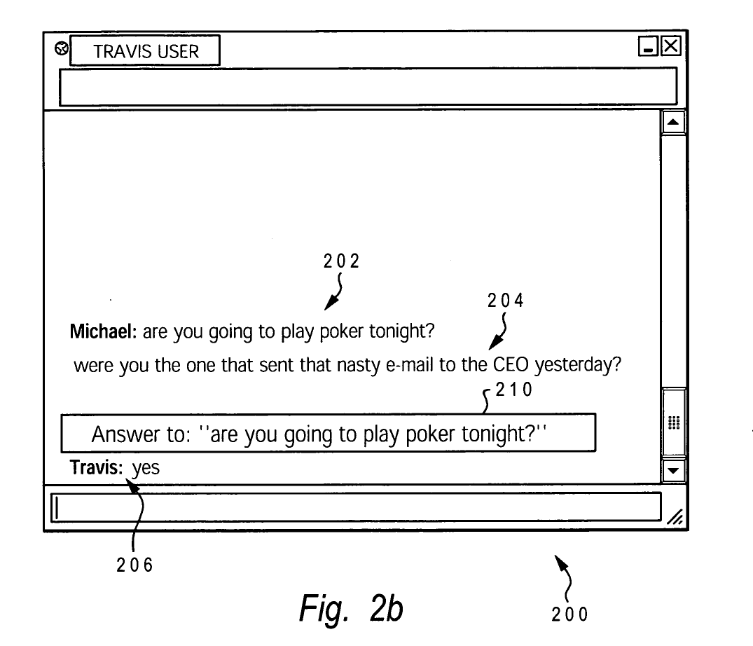

With reference now to FIG. 2a, an Instant Messaging (IM) User Interface (UI) 200 is shown in which a received text message 202 is associated with a response text message 206 by a visual cue (e.g., a line 208). This association can be performed by highlighting received text message 202 using mouse control, keyboard control (e.g., a “control-up arrow” combination or similar keystroke combinations), or by other similar means. By the use of a visual cue, it is clear that response text message 206 is not an answer to received text message 204, but rather is responding to received text message 202. When response text message 206 is sent back to the sending unit that sent the received text messages 202 and 204, the visual cue is also sent, such that the visual cue (e.g., line 208) is displayed on a UI at the sending unit, thus showing the association between received text message 202 and response text message 206.

As shown in FIG. 2b, an alternative to line 208 is a pop-up window 210, which textually displays (or alternatively describes using a metatag, line number, etc.) the appropriate received text message 202 to which response text message 206 is responding. In addition, the visual cue may be any similar type of visual written display, such as a “tool tip” that occurs when a cursor is hovered above response text message 206. Such a “tool tip” would display the same textual information shown in pop-up window 210.

Note that in one embodiment, the received text message is assumed to be (defaults to) the last entered received text message. That is, the visual cue (either line 208 shown in FIG. 2a or pop-up window 210 shown in FIG. 2b) is automatically assigned to the last entered received text message, which in the figures shown would be received text message 204. If “Travis” determines that the answer 206 is actually to a received text message that is not the last one entered (i.e., received text message 202), as is the case in FIGS. 2a-b, then the default condition can be overridden by manually highlighting received text message 202 as described above.

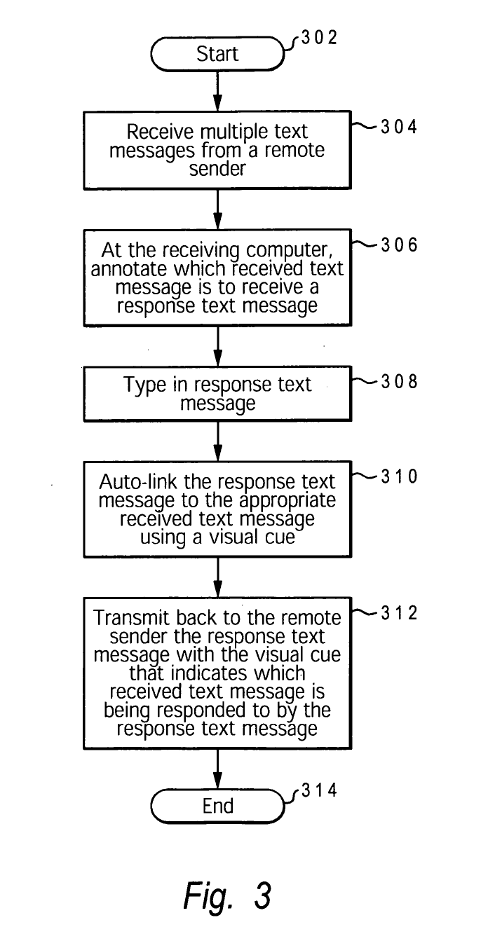

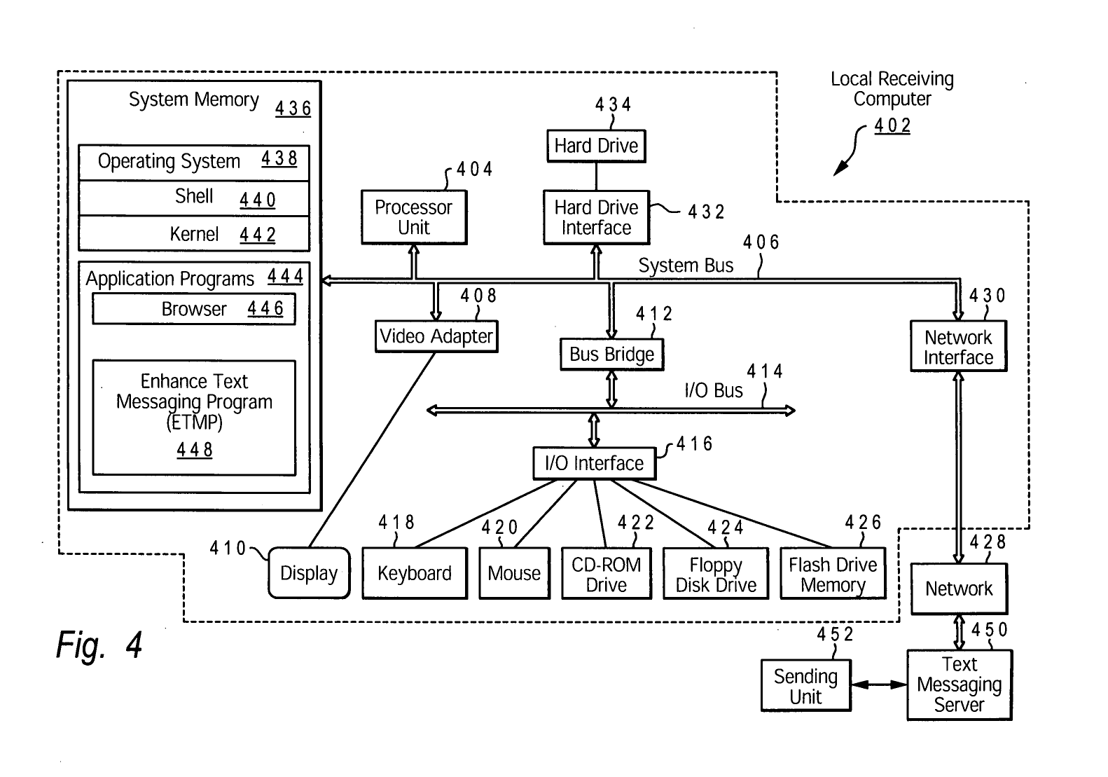

Referring now to FIG. 3, a flow-chart showing exemplary steps taken in the present invention is presented. After initiator block 302, multiple text messages (e.g., received text messages 202 and 204 shown in FIGS. 2a-b) are received (block 304) at a local receiver (e.g., local receiving computer 402 shown and described below in FIG. 4) from a remote sender (e.g., sending unit 452 shown and described below in FIG. 4). As described in block 306, at the receiving computer (e.g., local receiving computer 402), the specific received text message to which a response will be typed is annotated (such as by highlighting using a mouse, an “UP” arrow key, etc.). The response text message is then typed (block 308) at the local receiving computer. An Enhanced Text Messaging Program (ETMP) 448, shown and described below in FIG. 4, auto-links the typed response text message with the appropriate received text message (block 310), and displays a visual cue (such as shown in exemplary manner in FIGS. 2a-b). The response text message, along with the visual cue linking the response text message with the appropriate received text message, is then sent (block 312) back to the sending unit (sender of received text messages 202 and 204), and the process ends (terminator block 314).

Note that while the present invention has been described as a response text message being visually associated with a single received text message, alternatively the response text message could use the described visual cue(s) to visually associate the response text message with multiple received text messages. Likewise, multiple response text messages could use the above described visual cue(s) to associate the multiple response text messages with one or more received text messages.

With reference now to FIG. 4, there is depicted a block diagram of an exemplary local receiving computer 402, in which the present invention may be utilized. Local receiving computer 402 includes a processor unit 404 that is coupled to a system bus 406. A video adapter 408, which drives/supports a display 410, is also coupled to system bus 406. System bus 406 is coupled via a bus bridge 412 to an Input/Output (I/O) bus 414. An I/O interface 416 is coupled to I/O bus 414. I/O interface 416 affords communication with various I/O devices, including a keyboard 418, a mouse 420, a Compact Disk-Read Only Memory (CD-ROM) drive 422, a floppy disk drive 424, and a flash drive memory 426. The format of the ports connected to I/O interface 416 may be any known to those skilled in the art of computer architecture, including but not limited to Universal Serial Bus (USB) ports.

Local receiving computer 402 is able to communicate with a text messaging server 450 via a network 428 using a network interface 430, which is coupled to system bus 406. Network 428 may be an external network such as the Internet, or an internal network such as an Ethernet or a Virtual Private Network (VPN). Using network 428, local receiving computer 402 is able to access a remote sending unit 452 via text messaging server 450.

A hard drive interface 432 is also coupled to system bus 406. Hard drive interface 432 interfaces with a hard drive 434. In a preferred embodiment, hard drive 434 populates a system memory 436, which is also coupled to system bus 406. Data that populates system memory 436 includes local receiving computer 402's operating system (OS) 438 and application programs 444.

OS 438 includes a shell 440, for providing transparent user access to resources such as application programs 444. Generally, shell 440 is a program that provides an interpreter and an interface between the user and the operating system. More specifically, shell 440 executes commands that are entered into a command line user interface or from a file. Thus, shell 440 (as it is called in UNIX®), also called a command processor in Windows(, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 442) for processing. Note that while shell 440 is a text-based, line-oriented user interface, the present invention will equally well support other user interface modes, such as graphical, voice, gestural, etc.

As depicted, OS 438 also includes kernel 442, which includes lower levels of functionality for OS 438, including providing essential services required by other parts of OS 438 and application programs 444, including memory management, process and task management, disk management, and mouse and keyboard management.

Application programs 444 include a browser 446. Browser 446 includes program modules and instructions enabling a World Wide Web (WWW) client (i.e., local receiving computer 402) to send and receive network messages to the Internet using HyperText Transfer Protocol (HTTP) messaging, thus enabling communication, via a text messaging server 450, with a remote sending unit 452, which may have a hardware architecture similar (or exactly the same as) local receiving computer 402.

Application programs 444 in local receiving computer 402's system memory also include an Enhance Text Messaging Program (ETMP) 448. ETMP 448 includes code for implementing the processes described in FIG. 3. In one embodiment, ETMP 448 reads an identification (ID) tag in a header of a received text message, associates (based on a highlighting on the UI or by other means known to those skilled in the art) that received text message with the response text message that is responsive to that received text message, and then creates a visual cue (e.g., link 208 or pop-up window 210 described above as exemplary visual cues) that links that received text message with the appropriate response text message. When the response text message is sent back to the sending unit, the visual cue (along with the logical link that associates the response text message with the appropriate received text message) is sent back to the sending unit (e.g., sending unit 452), in which the visual cue is displayed on a UI at the sending unit. Note that the visual cue may also or alternatively be an aural cue (speech synthesized cue that describes the association between the response text message and the appropriate received text message), a tactile cue (using Braille-based or other tactile information systems), or any other appropriate means.

The hardware elements depicted in local receiving computer 402 are not intended to be exhaustive, but rather are representative to highlight essential components required by the present invention. For instance, local receiving computer 402 may include alternate memory storage devices such as magnetic cassettes, Digital Versatile Disks (DVDs), Bernoulli cartridges, and the like. These and other variations are intended to be within the spirit and scope of the present invention. Note also that local receiving computer 402 may be a desktop computer, a laptop computer, a Personal Digital Assistant (PDA), an e-mail capable wireless telephone, or any other similar device having instant messaging capability.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method comprising:
in an instant text messaging application that displays instant text messages on a User Interface (UI), displaying, on the UI, a visual cue that associates a response text message with one of a plurality of received text messages.

2. The method of claim 1, wherein the visual cue is a line that graphically connects the response text message to one of the plurality of received text messages.

3. The method of claim 1, wherein the visual cue is a pop-up window that textually describes an association of the response text message with one of the plurality of received text messages.

4. The method of claim 1, wherein an association of the response text message defaults to a last received text message, wherein the response text message is by default visually associated with the last received text message that is received before the response text message is typed into a UI of a receiving computer system.

5. The method of claim 1, further comprising:
providing an aural cue that associates the response text message with the one of the plurality of text messages.

6. The method of claim 1, further comprising:
transmitting the visual cue to a sending unit that sent the plurality of received text messages.

7. A system comprising:
a processor;
a data bus coupled to the processor;
a memory coupled to the data bus; and
a computer-usable medium embodying computer program code that includes an instant text message application that displays instant text messages on a User Interface (UI), the computer program code comprising instructions executable by the processor and configured for:
displaying, on the UI, a visual cue that associates a response text message with one of a plurality of received text messages.

8. The system of claim 7, wherein the visual cue is a line that graphically connects the response text message to one of the plurality of received text messages.

9. The system of claim 7, wherein the visual cue is a pop-up window that textually describes an association of the response text message with one of the plurality of received text messages.

10. The system of claim 7, wherein an association of the response text message defaults to a last received text message, wherein the response text message is by default visually associated with the last received text message that is received before the response text message is typed into a UI of a receiving computer system.

11. The system of claim 7, wherein the computer program code is further configured for:
providing an aural cue that associates the response text message with the one of the plurality of text messages.

12. The system of claim 7, wherein the computer program code is further configured for:
transmitting the visual cue to a sending unit that sent the plurality of received text messages.

13. A computer-usable medium embodying computer program code that includes an instant text messaging application that displays instant text messages on a User Interface (UI), the computer program code comprising computer executable instructions configured for:
displaying, on the UI, a visual cue that associates a response text message with one of a plurality of received text messages.

14. The computer-usable medium of claim 13, wherein the visual cue is a line that graphically connects the response text message to one of the plurality of received text messages.

15. The computer-usable medium of claim 13, wherein the visual cue is a pop-up window that textually describes an association of the response text message with one of the plurality of received text messages.

16. The computer-usable medium of claim 13, wherein an association of the response text message defaults to a last received text message, wherein the response text message is by default visually associated with the last received text message that is received before the response text message is typed into a UI of a receiving computer system.

17. The computer-usable medium of claim 13, wherein the embodied computer program code further comprises computer executable instructions configured for:
providing an aural cue that associates the response text message with the one of the plurality of text messages.

18. The computer-usable medium of claim 13, wherein the embodied computer program code further comprises computer executable instructions configured for:
transmitting the visual cue to a sending unit that sent the plurality of received text messages.
